(19) United States
(12) Patent Application Publication
(10) Pub. No.: US 2012/0063990 A1
(43) Pub. Date: Mar. 15, 2012

(54) METHOD FOR FORMING GRANULAR POLYNARY NANO COMPOUND

(76) Inventors: Hsing-Yu Tuan, Hsinchu (TW); Shu-Hao Chang, Hsinchu (TW); Ming-Yi Chiang, Hsinchu (TW)

(21) Appl. No.: 13/198,173

(22) Filed: Aug. 4, 2011

(30) Foreign Application Priority Data
Sep. 15, 2010 (TW) 099131126

(51) Int. Cl. C01B 19/00; C01G 15/00; B82Y 40/00

(52) U.S. Cl. 423/508; 423/511; 977/896

(57) ABSTRACT

The invention discloses a method for forming granular polynary nano compound, which comprises the steps of (S1) mixing at least two materials, selected from a pre-determined group, to contact it with a aliphatic amine to form a mixture; (S2) inputting a noble gas to the housing that the mixture disposed; (S3) heating the mixture to a first temperature and maintain at the first temperature for a first period; (S4) heating the mixture to the second temperature by a pre-determined heating rate and maintain at the second temperature for a second period; and (S5) precipitating the granular polynary nano compound from the mixture by a pre-determined way.

### BACKGROUND OF THE INVENTION

1. Field of the invention

The invention is related to a method for forming granular polynary nano compound. More particularly, the invention is related to the method for forming granular polynary nano compound with low-cost manufacturing and simple process.

2. Description of the prior art

In recent years, owing to the demand for renewable energy continuous growth, the technology of utilizing photonics to convert into electrical energy is growing up in high speed. Moreover, the main part is making the photoelectric conversion device by utilizing solid semiconductor materials.

Owing to the extensive research and development, photoelectric conversion materials and devices become cheaper and more efficient. In the past few decades, the manufacturing costs of photoelectric conversion materials have fallen a lot by the research and innovation of materials and manufacturing process, but the present manufacturing cost from the operation of the business still has a large improved space.

In the study of thin film solar cells, the main purpose of the research team is to invent the solar cells with low-cost manufacturing, simple process and mass production, wherein thin film solar cell is most appropriate. The types can be divided as amorphous silicon, cadmium telluride (CdTe) and copper indium gallium selenide (CIGS) according to materials.

For example, in case of U.S. Pat. No. 5,731,031, Bhattacharya and others provide the crystalline phase powders precursor for manufacturing solar cells by chemical bath, such as CuₓSeₙ (x=1-2, n=1-3), CuₓGa_{y}Se ₙ (x=1-2, y=0-1, n=1-3), CuₓIn_{y}Seₙ (x=1-2.27, y=0.72-2, n=1-3), Cuₓ(InGa)_{y} Seₙ (x=1-2.17, y=0.96-2, n=1-3) and In_{y}Seₙ (y=1-2.3, n=1-3) and so on. However, the slurry powders for synthesizing wet coating are crystalline phase. The control of powder composition, particle size uniformity and particle distribution uniformity are difficult. How to synthesize the slurry powders with easy control of powder composition, particle size uniformity and particle distribution uniformity is actively developing by many research groups in the present R&D.

### SUMMARY OF THE INVENTION

In view of the present problem, one scope of the present invention is providing a method for forming granular polynary nano compound.

In an embodiment of the present invention, the method for forming granular polynary nano compound comprises the following steps of: (S1) mixing at least two materials, selected from a pre-determined group, to contact it with a aliphatic amine to form a mixture; (S2) inputting a noble gas to a housing that the mixture disposed; (S3) heating the mixture to a first temperature and maintaining at the first temperature for a first period; (S4) heating the mixture to the second temperature by a pre-determined heating rate and maintaining at the second temperature for a second period; and (S5) precipitating the granular polynary nano compound from the mixture by a pre-determined way.

Moreover, in actual practice, the pre-determined group comprises a copper precursor, an indium precursor, a selenium precursor, a sulfide, a sulfur-containing material, a selenium compounds and a selenium-containing material. The first temperature is between 110 degrees Celsius and 150 degrees Celsius, the first period is between 50 minutes and 80 minutes. The method utilizes a way of inputting argon in sealed space for eliminating the oxygen and moisture in the mixture. Moreover, the pre-determined heating rate is less than 3 degrees Celsius per minute, the second temperature is between 220 degrees Celsius and 280 degrees Celsius, the second period is between 70 minutes and 110 minutes. The pre-determined way is adding a solvent to the mixture. The solvent comprises an ethanol or a hexane.

Moreover, the method for forming granular polynary nano compound further comprises the step of (S6) separating the granular polynary nano compound from the mixture. The separating way further comprises applying centrifugation to the mixture. Moreover, the average diameter of the granular polynary nano compound is 10 to 50 nm.

Compared to the prior art, the method for forming granular polynary nano compound of the present invention has the advantages of low-cost manufacturing, simple process and mass production. Moreover, the method overcomes the problem of the difficult control of powder composition, particle size uniformity and particle distribution uniformity.

The objective of the present invention will no doubt become obvious to those of ordinary skill in the art after reading the following detailed description of the preferred embodiment, which is illustrated in following figures and drawings.

### BRIEF DESCRIPTION OF THE APPENDED DRAWINGS

FIG. 1 is a flow diagram of a method for forming granular polynary nano compound of an embodiment of the invention.

FIG. 2 is a STEM-EDS mapping image of CuIn(S₁₋ₓSeₓ)₂ of the granular polynary nano compound of an embodiment of the invention.

FIG. 3 is a low-resolution transmission electron microscopy image of CuIn(S₁₋ₓSeₓ)₂ of the granular polynary nano compound of an embodiment of the invention.

FIG. 4 is a high-resolution transmission electron microscopy image of CuIn(S₁₋ₓSeₓ)₂ of the granular polynary nano compound of an embodiment of the invention.

FIG. 5 is a schematic diagram of the Composition, Lattice Parameters, and Optical Band Gap Energies of each material component of CuIn(S₁₋ₓSeₓ)₂ of the granular polynary nano compound of an embodiment of the invention.

FIG. 6 is a x-ray diffraction pattern of CuIn(S₁₋ₓSeₓ)₂ of the granular polynary nano compound of an embodiment of the invention.

### DETAILED DESCRIPTION OF THE INVENTION

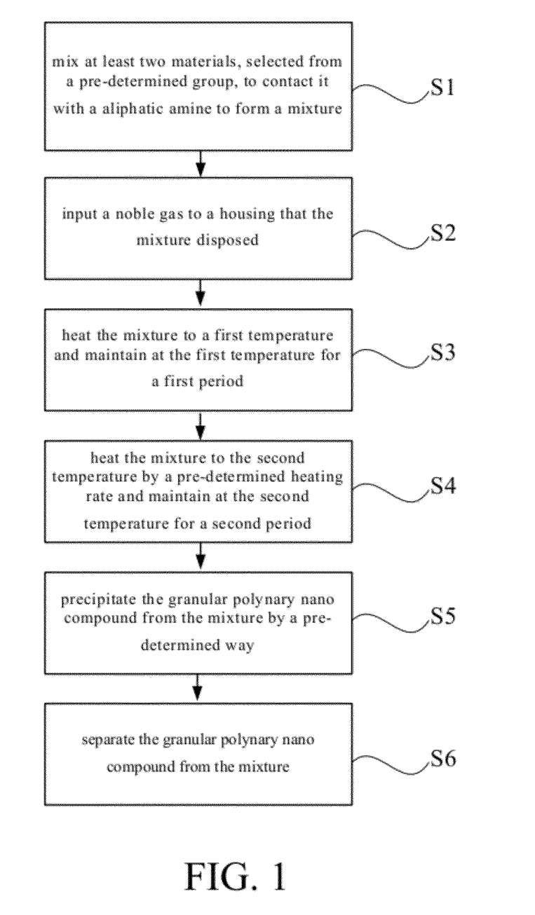

Please refer to FIG. 1. FIG. 1 is a flow diagram of a method for forming granular polynary nano compound of an embodiment of the invention. As shown in FIG. 1, the present invention discloses a method for forming granular polynary nano compound, comprising the following steps of: (S1) mixing at least two materials, selected from a pre-determined group, to contact it with a aliphatic amine to form a mixture; (S2) inputting a noble gas to a housing that the mixture disposed; (S3) heating the mixture to a first temperature and maintaining at the first temperature for a first period; (S4) heating the mixture to the second temperature by a pre-determined heating rate and maintaining at the second temperature for a second period; (S5) precipitating the granular polynary nano compound from the mixture by a pre-determined way; and (S6) separating the granular polynary nano compound from the mixture.

In the embodiment of the present invention, the granular polynary nano compound is a single crystal materials as CuIn(S₁₋ₓSeₓ)₂. However, the present invention can also be used to make CuInS₂, CuInSe₂, CuGaSe₂, CuInSe₂, Cu(InGa)Se₂, Cu₂ZnSnS₄, CuIn₁₋ₓGaₓ(S_{y}Se_{1-y})₂ etc., wherein x is greater than or Equal to zero, the number can be controlled by adjusting the molar ratio of input materials at startup process.

In the embodiment of the present invention, the granular polynary nano compound comprises a compound of four elements. However, depending on the needs of the manufacturing process of the present invention, the present invention can also be used to make a compound of three elements and a compound of five elements. Furthermore, the proportion of elements of the granular polynary nano compound is able to be increased or decreased by adjusting the molar ratio of each element in the process. When the proportion of various elements is increased or decreased, the corresponding physical features will also be different.

In the embodiment of the present invention, the granular polynary nano compound is a CuIn(S₁₋ₓSeₓ)₂, the method for forming granular polynary nano compound comprises the step of (S1) mixing at least two materials, selected from a pre-determined group, to contact it with a aliphatic amine to form a mixture. The pre-determined group comprises a copper precursor, an indium precursor, a selenium compounds or a selenium-containing material and a sulfide or a sulfur-containing material. In the embodiment of the present invention, the copper precursor is cuprous chloride, the indium precursor is indium trichloride, the selenium compounds or the selenium-containing material is an element of selenium, the sulfide or the sulfur-containing material is an element of sulfur, the aliphatic amine is an oleylamine.

Mix about 12 ml of oil amide, about 0.5 mmol (0.0495 g) of cuprous chloride, about 0.5 mmol (0.111 g) of indium trichloride, and the moderate amount of selenium and sulfur elements together into a mixture. The said moderate amount is that the total number of the selenium elements plus sulfur elements is 1 mmol, that means the weight of selenium may be 0 grams to 0.079 grams, the weight of sulfur may be 0 grams to 0.032 grams. Moreover, the weight is only meant the proportion of various elements, the proportion of various elements can be increased or decrease in ratio of equality. The user of the belonging field should be able to reasonably change the proportion of various elements according to their background knowledge or prior technology. The said contacting and mixing method can be adjusted according to the various parameters such as the ratio of specific materials, process needs, material properties, size of nanoparticles and so on.

In the step of (S2) inputting a noble gas to a housing that the mixture disposed, in the embodiment of the present invention, the purpose of inputting a noble gas to a housing that the mixture disposed is to eliminate the oxygen and water at the housing that the mixture disposed. In the embodiment of the present invention, the noble gas is argon. However, it does not take argon as necessary, it can be another gas which may not affect processes and eliminate the oxygen and water. Moreover, the order of the details of the steps of (S1), (S2) and (S3) is able to be changed according to the needs of process. For example, the user can apply the step of (S2) inputting a noble gas to a housing that the mixture disposed first, and then applies the step of (S1) mixing at least two materials, selected from a pre-determined group, to contact it with a aliphatic amine to form a mixture, and apply the step of (S3) heating the mixture to a first temperature and maintaining at the first temperature for a first period at last.

In the step of (S3) heating the mixture to a first temperature and maintaining at the first temperature for a first period at last, in the embodiment of the present invention, the first temperature is between 110 degrees Celsius and 150 degrees Celsius, the first period is between 50 minutes and 80 minutes. The said first temperature and first period can be adjusted according to the various parameters such as the ratio of specific materials, process needs, material properties, size of nanoparticles and so on. Moreover, the mixture should be stirred continuously for reaching the best effect when the steps of (S1), (S2) and (S3) are applied.

In the step of (S4) heating the mixture to the second temperature by a pre-determined heating rate and maintaining at the second temperature for a second period, the pre-determined heating rate is less than 3 degrees Celsius per minute, the second temperature is between 220 degrees Celsius and 280 degrees Celsius and the second period is between 70 minutes and 110 minutes. In the embodiment of the present invention, it can reach the best effect when the pre-determined heating rate is 2.3 degrees Celsius per minute, the second temperature is between 240 degrees Celsius and 265 degrees Celsius and the second period is 90 minutes. If the said pre-determined heating rate is over high, the granular polynary nano compound will be flawed and be significantly detracted from its effectiveness. Therefore, the heating rate of the mixture should be controlled at the rate less than 3 degrees Celsius per minute. Moreover, the quality will be increased if the mixture is stirred continuously and strongly when the step of (S4) is applied.

In the step of (S5) precipitating the granular polynary nano compound from the mixture by a pre-determined way, in the embodiment of the present invention, the pre-determined way is to add a solvent to the mixture for precipitating the granular polynary nano compound at the bottom of the container. In the embodiment of the present invention, the solvent comprises an ethanol and hexane. Moreover, the ethanol and the hexane are 10 ml and 15 ml respectively for matching the proportion of various elements of the step of (S1).

In the step of (S6) separating the granular polynary nano compound from the mixture, in the embodiment of the present invention, the way for separating the granular polynary nano compound from the mixture is to apply centrifugation to the mixture, that is to rotate the mixture at the frequency about 8000 rpm for increasing the precipitation speed of the granular polynary nano compound and make the collection of materials more easily. However, the granular polynary nano compound can be collected by filtrating the mixture or waiting the natural deposition of the mixture or other prior way. After the granular polynary nano compound is separated from the mixture, the granular polynary nano compound is able to be separated again to extract the granular polynary nano compound for increasing the purity of the granular polynary nano compound by utilizing the hexane, the toluene, the chloroform or other non-polar organic solvents at the mixture for cooling down to the ambient temperature. Moreover, the average diameter of the granular polynary nano compound is 10 to 50 nm.

To confirm that the method for forming granular polynary nano compound of the present invention is effective, an analysis is utilized to analyze the product of the method. The analysis is scanning transmission electron microscopy (STEM), low-resolution transmission electron microscopy (LRTEM), high-resolution transmission electron microscopy (HRTEM), x-ray energy dispersive spectrometer (EDS), X-ray diffraction (XRD) and UV-vis-NIR spectrometer (UV-vis-NIR) respectively.

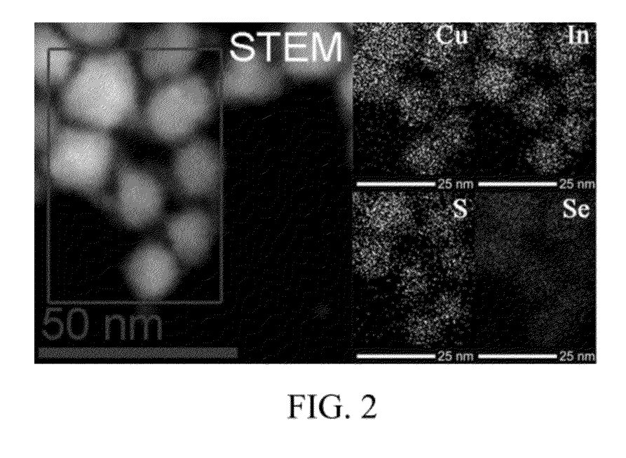

Please refer to FIG. 2, FIG. 2 is a scanning transmission electron microscopy image of CuIn(S₁₋ₓSeₓ)₂ of the granular polynary nano compound of an embodiment of the invention. As shown in FIG. 2, the copper (Cu), indium (In), sulfur (S), selenium (Se) and other elements are able to be seen that uniformly distributed in the nano-particles by the elemental composition analysis mode of STEM, the results of the nano-particles are confirmed as CuIn(S₁₋ₓSe.)₂.

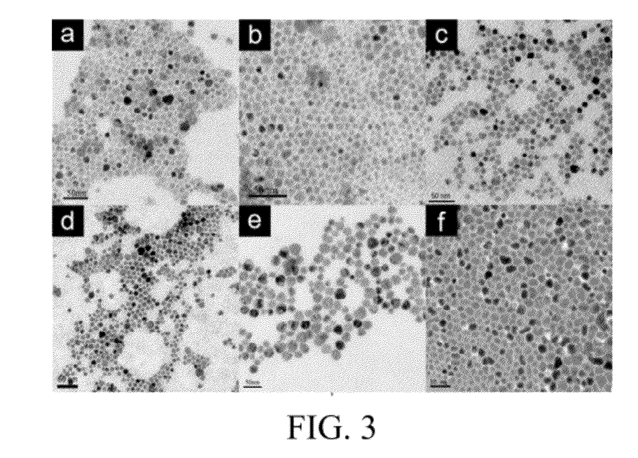

Please refer to FIG. 3, FIG. 3 is a low-resolution transmission electron microscopy image of CuIn(S₁₋ₓSeₓ)₂ of the granular polynary nano compound of an embodiment of the invention. Please refer to FIG. 2 and FIG. 3, as shown in FIG. 2 and FIG. 3, the distribution of the copper (Cu), indium (In), sulfur (S) and selenium (Se) is good and uniform. Moreover, as shown in the image, the average diameter of the granular polynary nano compound is 10 to 50 nm.

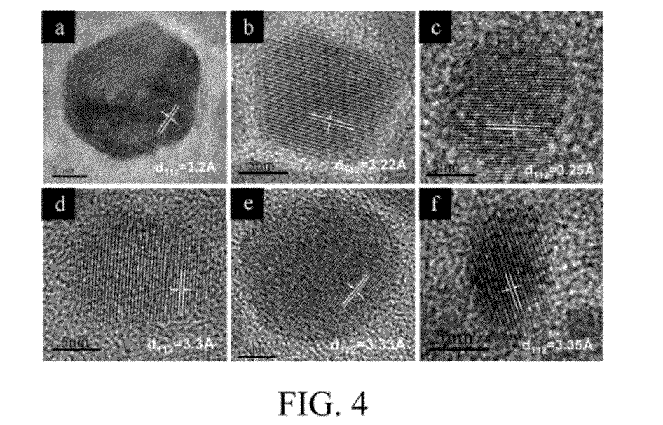

Please refer to FIG. 4, FIG. 4 is a high-resolution transmission electron microscopy image of CuIn(S₁₋ₓSeₓ)₂ of the granular polynary nano compound of an embodiment of the invention. As shown in FIG. 4, the lattice spacing (d-spacing) is increased as the proportion of selenium is increased.

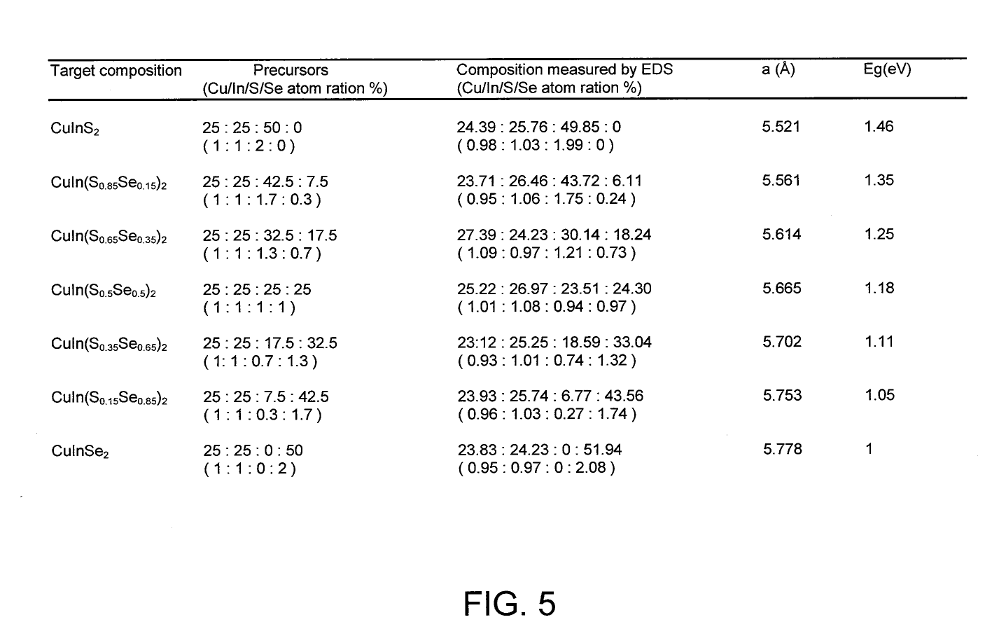

Please refer to FIG. 5, FIG. 5 is a schematic diagram of the physical properties of each material component of CuIn(S₁₋ₓSeₓ)₂ of the granular polynary nano compound of an embodiment of the invention. As shown in FIG. 5, the parameter of lattice and the band gap energy are changed as the proportion of selenium and sulfur is changed.

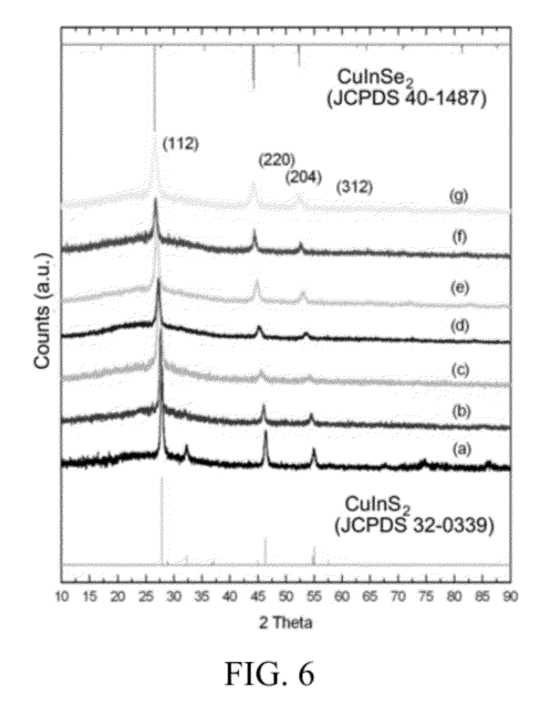

Please refer to FIG. 6, FIG. 6 is a x-ray energy dispersive spectrometer image of CuIn(S₁₋ₓSeₓ)₂ of the granular polynary nano compound of an embodiment of the invention. As shown in FIG. 6, the x-ray diffraction peaks shift to left as the proportion of selenium is increased.

In the FIG. 3, FIG. 4 and FIG. 6, the images are to represent (a) CuInS₂, (b) CuIn(S_{0.85}Se_{0.15})₂, (c) CuIn(S_{0.65}Se_{0.35})₂, (d) CuIn(S_{0.35}Se_{0.65})₂, (e) CuIn(S_{0.15}Se_{0.85})₂ and (f) CuInSe₂ respectively.

Compared to the prior art, the method for forming granular polynary nano compound of the present invention has the advantages of low-cost manufacturing, simple process and mass production. Moreover, the method overcomes the problem of the difficult control of powder composition, particle size uniformity and particle distribution uniformity.

Although the present invention has been illustrated and described with reference to the preferred embodiment thereof, it should be understood that it is in no way limited to the details of such embodiment but is capable of numerous modifications within the scope of the appended claims.

What is claimed is:

1. A method for forming granular polynary nano compound, comprising the following steps of:
(S1) mixing at least two materials, selected from a pre-determined group, to contact it with a aliphatic amine to form a mixture;
(S2) inputting a noble gas to a housing that the mixture disposed;
(S3) heating the mixture to a first temperature and maintaining at the first temperature for a first period;
(S4) heating the mixture to the second temperature by a pre-determined heating rate and maintaining at the second temperature for a second period; and
(S5) precipitating the granular polynary nano compound from the mixture by a pre-determined way.

2. The method for forming granular polynary nano compound of claim 1, wherein the pre-determined group of (S1) comprises a copper precursor, an indium precursor, a selenium precursor, a sulfide, a sulfur-containing material, a selenium compounds and a selenium-containing material.

3. The method for forming granular polynary nano compound of claim 1, wherein the first temperature of (S3) is between 110 degrees Celsius and 150 degrees Celsius.

4. The method for forming granular polynary nano compound of claim 1, wherein the first period of (S3) is between 50 minutes and 80 minutes.

5. The method for forming granular polynary nano compound of claim 1, wherein the pre-determined heating rate of (S4) is less than 3 degrees Celsius per minute.

6. The method for forming granular polynary nano compound of claim 1, wherein the second temperature of (S4) is between 220 degrees Celsius and 280 degrees Celsius.

7. The method for forming granular polynary nano compound of claim 1, wherein the second period of (S4) is between 70 minutes and 110 minutes.

8. The method for forming granular polynary nano compound of claim 1, wherein the pre-determined way of (S5) is adding a solvent to the mixture.

9. The method for forming granular polynary nano compound of claim 8, wherein the solvent of (S5) comprises an ethanol and a hexane.

10. The method for forming granular polynary nano compound of claim 1, wherein the average diameter of granular polynary nano compound is between 10 nanometers and 50 nanometers.

11. The method for forming granular polynary nano compound of claim 1, further comprising the step of (S6) separating the granular polynary nano compound from the mixture.

12. The method for forming granular polynary nano compound of claim 11, wherein the step of (S6) further comprises applying centrifugation to the mixture.
